(19) United States
(12) Patent Application Publication
(10) Pub. No.: US 2020/0065771 A1
(43) Pub. Date: Feb. 27, 2020

(54) LOCATION-BASED AUGMENTED REALITY FOR JOB SEEKERS

(71) Applicant: CareerBuilder, LLC, Chicago, IL (US)

(72) Inventors: Brian Gaspar, Los Gatos, CA (US); Mark Alan Patterson, JR., Brookhaven, GA (US); Faizan Javed, Peach Tree Corners, GA (US); Janani Balaji, Cumming, GA (US); Robert Malony, Daytona Beach, FL (US); Carl Eric Presley, Peach Tree Corners, GA (US); Humair Ghauri, San Ramon, CA (US)

(21) Appl. No.: 16/546,791

(22) Filed: Aug. 21, 2019

Related U.S. Application Data
(60) Provisional application No. 62/722,677, filed on Aug. 24, 2018.

(51) Int. Cl. G06Q 10/10; G06T 11/00; G09G 5/373; H04W 4/02

(52) U.S. Cl. CPC G06Q 10/1053; G06T 11/00; G09G 5/373; H04W 4/026; G06T 2200/24; G09G 2340/045; G09G 2340/0464; G09G 2340/12; H04W 4/023

(57) ABSTRACT

Methods and apparatus are disclosed for location-based augmented reality for job seekers. An example system includes a mobile device and a remote server. The mobile device includes a camera to collect video and a processor configured to execute an employment app to generate, in real-time, a computer-generated layer that includes a balloon for each of the employment locations. The processor also is configured to execute the employment app to generate, in real-time, an augmented reality interface by overlaying the computer-generated layer onto the video. A display location and a display size for each of the balloons indicate the employment locations to the employment candidate. The mobile device includes a display to display the augmented reality interface. The remote server is configured to identify up to the predetermined number of the employment locations. Each of the employment locations corresponds with one or more employment postings.

### CROSS-REFERENCE TO RELATED APPLICATION

This application claims the benefit of U.S. Provisional Patent Application No. 62/722,677, filed on Aug. 24, 2018, which is incorporated by reference in its entirety.

### TECHNICAL FIELD

The present disclosure generally relates to augmented reality and, more specifically, to location-based augmented reality for job seekers.

### BACKGROUND

Typically, employment websites (e.g., CareerBuilder.com®) are utilized by employers and job seekers. Oftentimes, an employment website incorporates a job board on which employers may post positions they are seeking to fill. In some instances, the job board enables an employer to include duties of a position and/or desired or required qualifications of job seekers for the position. Additionally, the employment website may enable a job seeker to search through positions posted on the job board. If the job seeker identifies a position of interest, the employment website may provide an application to the job seeker for the job seeker to fill out and submit to the employer via the employment website.

An employment website may include thousands of job postings for a particular location and/or field of employment. Further, each job posting may include a great amount of detailed information related to the available position. For instance, a job posting may include a name of the employer, a summary of the field in which the employer operates, a history of the employer, a summary of the office culture, a title of the available position, a description of the position, work experience requirements, work experience preferences, education requirements, education preferences, skills requirements, skills preferences, a location of the available position, a potential income level, potential benefits, expected hours of work for the position, etc. As a result, a job seeker potentially may become overwhelmed when combing through the descriptions of available positions found on an employment website. In turn, a job seeker potentially may find it difficult to find potential positions of interest.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for location-based augmented reality for job seekers. An example disclosed system for providing location-based augmented reality for an employment candidate includes a mobile device. The mobile device includes a camera to collect video. The mobile device also includes a communication module configured to transmit, via wireless communication, a current location and a current orientation of the mobile device and receive, via wireless communication, up to a predetermined number of employment locations. The mobile device also includes memory configured to store an employment app and a processor configured to execute the employment app. The processor is configured to execute the employment app to generate, in real-time, a first computer-generated layer that includes a balloon for each of the employment locations. To generate the balloon for each of the employment locations, the employment app is configured to determine a display location of the balloon within the first computer-generated layer based on the employment location, the current location of the mobile device, and the current orientation of the mobile device. To generate the balloon for each of the employment locations, the employment app also is configured to determine a display size of the balloon based on a distance between the current location of the mobile device and the employment location. A larger display size corresponds with a shorter distance. The processor also is configured to execute the employment app to generate, in real-time, a first augmented reality (AR) interface by overlaying the first computer-generated layer onto the video captured by the camera. The mobile device also includes a display configured to display, in real-time, the first AR interface. The display location and the display size of each of the balloons indicate the employment locations to the employment candidate. The example disclosed system also includes a remote server configured to collect, via wireless communication, the current location and the current orientation of the mobile device and identify up to the predetermined number of the employment locations based on, at least in part, the current location and the current orientation of the mobile device. Each of the employment locations corresponds with one or more employment postings. The remote server also is configured to transmit, via wireless communication, the employment locations to the mobile device.

In some examples, the processor of the mobile device is configured to execute the employment app to dynamically adjust, in real-time, the display locations and the display sizes of the balloons of the first AR interface based on detected movement of the mobile device. In some examples, each of the balloons includes text identifying the distance to the corresponding employment location. In some examples, the first computer-generated layer further includes a radial map located near a corner of the first AR interface. In such examples, the radial map includes a center corresponding to the current location of the mobile device, a sector that identifies the current orientation of the mobile device, and dots outside of the sector that identify other employment locations surrounding the current location of the mobile device.

In some examples, the processor of the mobile device is configured to execute the employment app to collect employment preferences from the employment candidate via the mobile device. In some such examples, the employment preferences include a preferred employment title, a preferred income level, a preferred employment region, and a preferred maximum commute distance. In some such examples, the remote server is configured to generate a candidate profile based on, at least in part, the employment preferences collected by the employment app. Further, in some such examples, the remote server is configured to generate the candidate profile further based on at least one of search history within the employment app and social media activity of the employment candidate. In some such examples, the remote server is configured to calculate a match score for each of a plurality of employment postings. In such examples, the match score indicates a likelihood that the employment candidate is interested in the employment posting. Further, in some such examples, the remote server is configured to determine the employment locations of the employment postings for the first AR interface further based on the match scores of the plurality of employment postings. Moreover, in some such examples, the match score of each of the employment postings identified by the remote server is greater than a predetermined threshold.

An example disclosed method for providing location-based augmented reality for an employment candidate includes detecting a current location and a current orientation of a mobile device. The example disclosed method also includes receiving, via wireless communication, up to a predetermined number of employment locations that are identified based on, at least in part, the current location and the current orientation of the mobile device. Each of the employment locations corresponds with one or more employment postings. The example disclosed method also includes capturing video via a camera of the mobile device and generating, in real-time via a processor of the mobile device, a first computer-generated layer that includes a balloon for each of the employment locations. Generating the first computer-generated layer includes determining a display location of the balloon within the first computer-generated layer based on the employment location, the current location of the mobile device, and the current orientation of the mobile device. Generating the first computer-generated layer also includes determining a display size of the balloon based on a distance between the current location of the mobile device and the employment location. A larger display size corresponds with a shorter distance. The example disclosed method also includes generating, via the processor, a first augmented reality (AR) interface in real-time by overlaying the first computer-generated layer onto the video captured by the camera and displaying the first AR interface in real-time via a touchscreen of the mobile device. The display location and the display size of each of the balloons are configured to indicate the employment locations to the employment candidate.

Some examples further include dynamically adjusting, in real-time, the display locations and the display sizes of the balloons of the first AR interface based on detected movement of the mobile device. Some examples further include displaying, via the touchscreen, text in each of the balloons that identifies the distance to the corresponding employment location. Some examples further include displaying, via the touchscreen, a radial map in the first computer-generated layer that is located near a corner of the first AR interface. The radial map includes a center corresponding to the current location of the mobile device, a sector that identifies the current orientation of the mobile device, and dots outside of the sector that identify other employment locations surrounding the current location of the mobile device.

Some examples further include, in response to identifying that the employment candidate selected one of the balloons via the touchscreen, collecting information for each of the employment postings at the employment location corresponding with the selected balloon; generating, in real-time, a second computer-generated layer that includes a list of summaries for the employment postings at the employment location corresponding with the selected balloon; generating, in real-time, a second AR interface by overlaying the second computer-generated layer onto the video captured by the camera; and displaying, in real-time, the second AR interface via the touchscreen. Some such examples further include, in response to identifying that the employment candidate selected one of the summaries via the touchscreen, generating, in real-time, a third computer-generated layer that includes a submit button, a directions button, and a detailed description of a selected employment posting corresponding with the selected summary; generating, in real-time, a third AR interface by overlaying the third computer-generated layer onto the video captured by the camera; and displaying, in real-time, the third AR interface via the touchscreen. Further, some such examples further include submitting a resume to an employer for the selected employment posting in response to identifying that the employment candidate selected the submit button via the touchscreen. Further, some such examples further include determining and presenting directions to the employment candidate for traveling from the current location to the selected employment location in response to identifying that the employment candidate selected the directions button via the touchscreen.

An example disclosed computer readable medium includes instructions which, when executed, cause a mobile device to detect a current location and a current orientation of the mobile device. The instructions, when executed, also cause the mobile device to receive, via wireless communication, up to a predetermined number of employment locations that are identified based on, at least in part, the current location and the current orientation of the mobile device. Each of the employment locations corresponds with one or more employment postings. The instructions, when executed, also cause the mobile device to capture video via a camera of the mobile device. The instructions, when executed, also cause the mobile device to generate, in real-time, a first computer-generated layer that includes a balloon for each of the employment locations by determining a display location of the balloon within the first computer-generated layer based on the employment location, the current location of the mobile device, and the current orientation of the mobile device and determining a display size of the balloon based on a distance between the current location of the mobile device and the employment location. A larger display size corresponds with a shorter distance. The instructions, when executed, also cause the mobile device to generate a first augmented reality (AR) interface in real-time by overlaying the first computer-generated layer onto the video captured by the camera and display the first AR interface in real-time via a display of the mobile device. The display location and the display size of each of the balloons are configured to indicate the employment locations to the employment candidate.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example environment in which an employment website entity presents employment information to a job seeker via a location-based augmented reality employment app in accordance with the teachings herein.

FIG. 2 is a block diagram of electronic components of the employment website entity of FIG. 1.

FIG. 3 is a block diagram of electronic components of a mobile device of the job seeker of FIG. 1.

FIG. 4 illustrates an example interface of the employment app of FIG. 1.

FIG. 5 illustrates another example interface of the employment app of FIG. 1.

FIG. 6 illustrates a first portion of another example interface of the employment app of FIG. 1.

FIG. 7 illustrates another example interface of the employment app of FIG. 1.

FIG. 8 illustrates a second portion of the interface of FIG. 6.

FIG. 9 illustrates another example interface of the employment app of FIG. 1.

FIG. 10 illustrates another example interface of the employment app of FIG. 1.

FIG. 11 illustrates another example interface of the employment app of FIG. 1.

FIG. 12 illustrates another example interface of the employment app of FIG. 1.

FIG. 13 illustrates another example interface of the employment app of FIG. 1 in a first state.

FIG. 14 illustrates the interface of FIG. 13 in a second state.

FIG. 15 illustrates another example interface of the employment app of FIG. 1.

FIGS. 16A-16D is a flowchart for presenting employment information to a job seeker via a location-based augmented reality employment app in accordance with the teachings herein.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

The example methods and apparatus disclosed herein includes an employment app for a job seeker that presents augmented reality interfaces on a touchscreen of a mobile device (e.g., a smart phone, a tablet, a wearable, etc.) to enable the job seeker to identify and locate employment postings for nearby employment opportunities while performing everyday tasks (e.g., lounging at home, working, traveling to work, running errands, hanging out with friends, etc.). Examples disclosed herein include improved user interfaces for computing devices that are particularly structured to present various levels of detailed information for nearby employment opportunities that match employment preferences of a job seeker in a manner that is intuitive for the job seeker. More specifically, example interfaces disclosed herein are specifically configured to facilitate the collection of employment preferences and/or the presentation of employment postings information on small screens of mobile devices (e.g., smart phones, tablets, etc.), which are being used more-and-more over time as a primary computing device. For example, augmented reality interfaces disclosed herein are configured to be presented via a touchscreen of a mobile device in a manner that enables a job seeker to quickly identify an employment opportunity of interest. Thus, the examples disclosed herein include a specific set of rules that provide an unconventional technological solution of selectively presenting job postings for nearby employment opportunities within an augmented reality interface for a mobile device to a technological problem of providing assistance to job seekers in navigating job postings of an employment website on a mobile device.

As used herein, an “employment website entity” refers to an entity that operates and/or owns an employment website and/or an employment app. As used herein, an “employment website” refers to a website and/or any other online service that facilitates job placement, career, and/or hiring searches. Example employment websites include CareerBuilder.com®, Sologig.com®, etc. As used herein, an “employment app” and an “employment application” refer to a process of an employment website entity that is executed on a mobile device, a desktop computer, and/or within an Internet browser of a candidate. For example, an employment application includes a mobile app that is configured to operate on a mobile device (e.g., a smart phone, a smart watch, a wearable, a tablet, etc.), a desktop application that is configured to operate on a desktop computer, and/or a web application that is configured to operate within an Internet browser (e.g., a mobile-friendly and/or responsive-design website configured to be presented via a touchscreen of a mobile device). As used herein, a “candidate” and a “job seeker” refer to a person who is searching for a job, position, and/or career.

As used herein, “real-time” refers to a time period that is simultaneous to and/or immediately after a candidate enters a keyword into an employment website. For example, real-time includes a time duration before a session of the candidate with an employment app ends. As used herein, a “session” refers to an interaction between a job seeker and an employment app. Typically, a session will be relatively continuous from a start point to an end point. For example, a session may begin when the candidate opens and/or logs onto the employment website and may end when the candidate closes and/or logs off of the employment website.

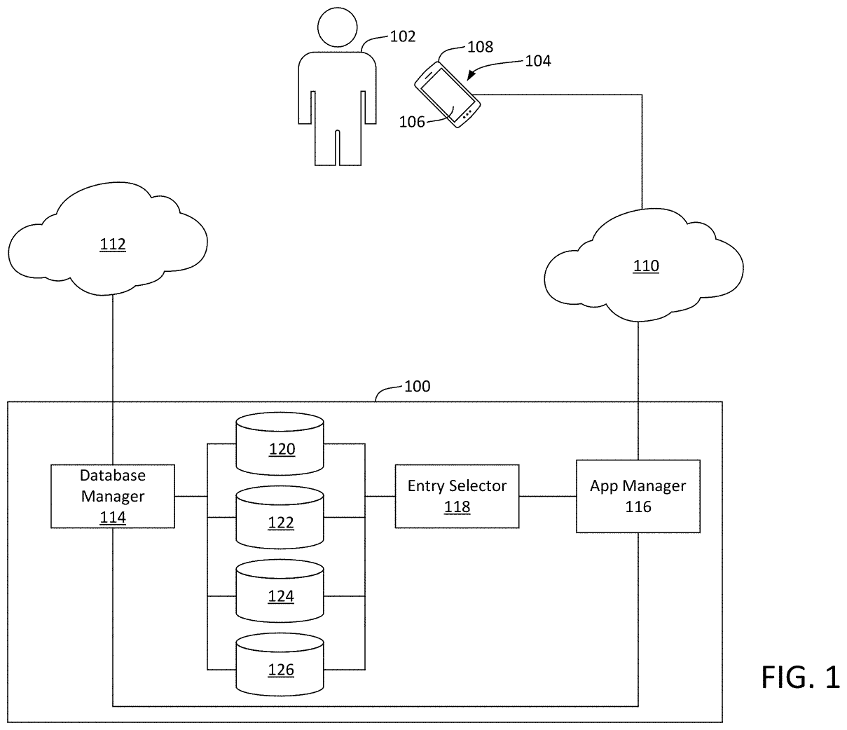

Turning to the figures, FIG. 1 illustrates an example remote server 100 of an employment website entity (e.g., CareerBuilder.com®) that enables presentation of employment opportunities and submits applications for a candidate 102 via an employment app 104 in accordance with the teachings herein. In the illustrated example, a touchscreen 106 of a mobile device 108 (e.g., a smartphone, a tablet, etc.) presents the employment app 104. For example, the touchscreen 106 is (1) an output device that presents interfaces of the employment app 104 to the candidate 102 and (2) an input device that enables the candidate 102 to input information by touching the touchscreen 106. In the illustrated example, the candidate 102 interacts with the employment app 104 during a session of the candidate 102 on the employment app 104.

As illustrated in FIG. 1, the mobile device 108 of the candidate 102 and the remote server 100 of the employment website entity are in communication with each other via a network 110 (e.g., via a wired and/or a wireless connection). The network 110 may be a public network, such as the Internet; a private network, such as an intranet; or combinations thereof. The remote server 100 of the employment website entity of the illustrated example also is in communication with another network 112 (e.g., via a wired and/or a wireless connection). The network 112 may be a public network, such as the Internet; a private network, such as an intranet; or combinations thereof. In the illustrated example, the network 112 is separate from the network 110. In other examples, the network 110 and the network 112 are integrally formed.

The remote server 100 of the employment website entity in the illustrated example includes a database manager 114, an app manager 116, an entry selector 118, a search history database 120, a social media database 122, a profile database 124, and a postings database 126. The database manager 114 adds, removes, modifies, and/or otherwise organizes data within the search history database 120, the social media database 122, the profile database 124, and the postings database 126. The app manager 116 controls, at least partially, operation of the employment app 104 by collecting, processing, and providing information for the employment app 104 via the network 110. The entry selector 118 selects information to retrieve and retrieves the information from the search history database 120, the social media database 122, the profile database 124, and/or the postings database 126. Further, the search history database 120 stores search history of the candidate 102 within the employment app 104. The social media database 122 stores social media activity of the candidate 102. The profile database 124 stores employment preferences and/or a candidate profile of the candidate 102. The postings database 126 stores information regarding employment postings submitted to the employment website entity by employers.

In operation, the database manager 114 constructs the search history database 120 and organizes links between search history and the candidate 102. For example, the database manager 114 constructs the search history database 120 based on search history of the candidate 102 that is collected from the employment app 104 via the app manager 116. Further, the database manager 114 constructs the social media database 122 and organizes links between social media activity and the candidate 102. For example, the database manager 114 constructs the social media database 122 based on social media activity information that is collected from the network 112. The database manager 114 also constructs the postings database 126 and organizes links between employment postings and corresponding details of the postings. For example, the database manager 114 constructs the postings media database 126 based on information submitted by employers and/or otherwise collected from the network 112.

Further, the database manager 114 constructs the profile database 124 and organizes links between employment preferences, candidate profiles, and the candidate 102. For example, the database manager 114 constructs the profile database 124, at least in part, based on employment preferences (e.g., a preferred employment title, a preferred income level, a preferred employment region, a preferred maximum commute distance) that are collected from the candidate 102 by the employment app 104. The database manager 114 also constructs the profile database 124, at least in part, based on a candidate profile that is generated by the app manager 116 of the remote server 100 of the employment website entity. For example, the app manager 116 generates the candidate profile based on the employment preferences, the search history, and/or the social media activity of the candidate 102.

Once the databases 120, 122, 124, 126 are constructed by the database manager 114, the app manager 116 of the remote server 100 collects a current location and a current orientation of the mobile device 108 via the network 110 and/or wireless communication with the mobile device 108. Further, the app manager 116 identifies up to a predetermined number of employment locations based on, at least in part, the current location and the current orientation of the mobile device 108. Each of the identified employment locations corresponds with one or more employment postings stored within the postings database 126.

To determine which employment locations to identify, the app manager 116 calculates respective match scores for a plurality of the employment postings stored in the postings database 126. Each of the match scores indicates a likelihood that the candidate 102 is interested in the corresponding employment opportunity. In turn, the app manager 116 determines which of the employment locations to identify based on the match scores of the employment postings that correspond to the employment locations. For example, if a match score of an employment posting is greater than a predetermined threshold, the app manager 116 selects the employment location of the employment posting that corresponds with the high match score.

Further, the app manager 116 of the remote server 100 transmits information related to the identified employment locations and/or employment postings to the employment app 104 of the mobile device 108 via the network 110 and/or wireless communication with the mobile device 108. The employment app 104 generates, in real-time, a computer-generated (CG) layer that includes a balloon for each of the identified employment locations and/or employment postings. To generate a balloon, the employment app 104 determines a display location for the balloon within the CG layer based on the corresponding employment location, the current location of the mobile device 108, and the orientation of the mobile device 108. To generate a balloon, the employment app 104 also determines a display size for the balloon on the CG layer based on a distance between the corresponding employment location and the current location of the mobile device 108. For example, a larger display size corresponds with a shorter distance, and a smaller display size corresponds with a longer distance.

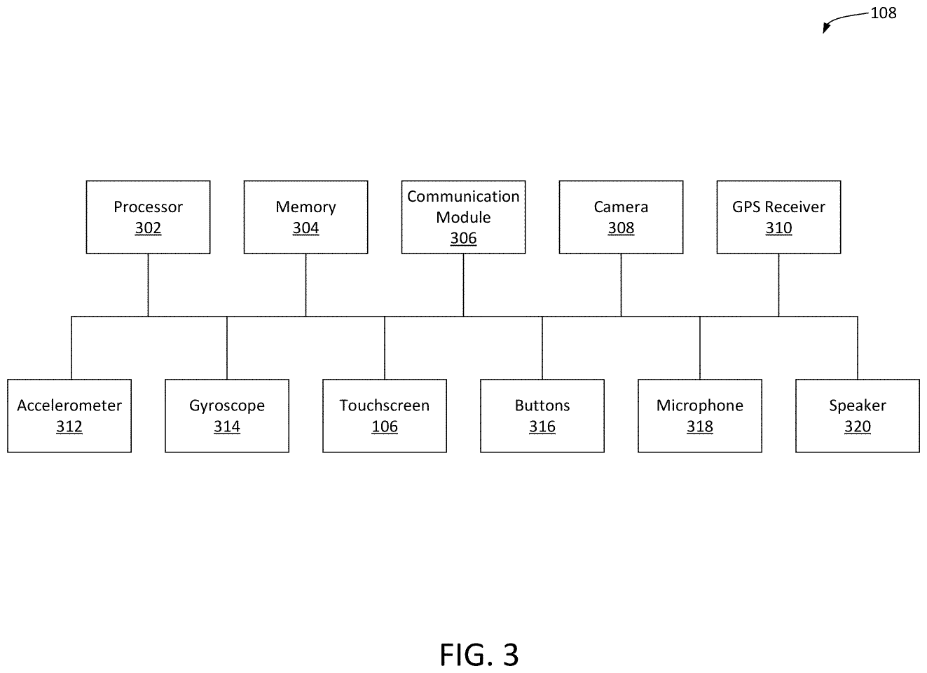

The employment app 104 also collects video captured by a camera of the mobile device 108 (e.g., a camera 308 of FIG. 3). Upon collecting the video and generating the CG layer, the employment app 104 generates, in real-time, an augmented reality (AR) interface (e.g., an AR interface 900 of FIG. 9) by overlaying the CG layer onto the video captured by the camera. Further, the employment app 104 displays, in real-time, the AR interface via the touchscreen 106 of the mobile device 108. The display location and the display size for each of the balloons of the AR interface enables the candidate 102 to intuitively identify nearby employment opportunities that are of interest to the candidate 102.

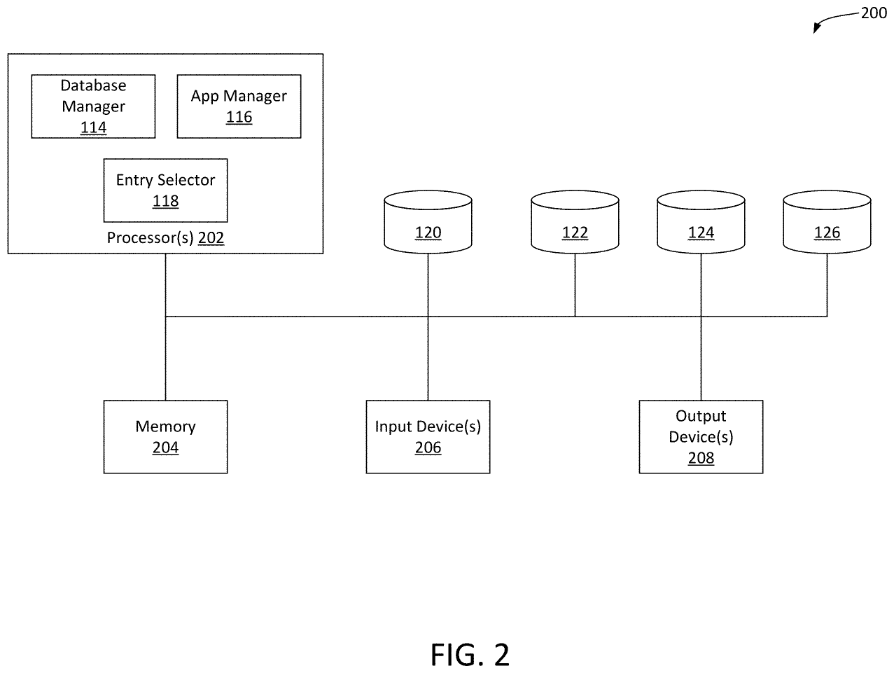

FIG. 2 is a block diagram of electronic components 200 of the remote server 100 of the employment website entity. As illustrated in FIG. 2, the electronic components 200 include one or more processors 202 (also referred to as microcontroller unit(s) and controller(s)). Further, the electronic components 200 include the search history database 120, the social media database 122, the profile database 124, the postings database 126, memory 204, input device(s) 206, and output device(s) 208. In the illustrated example, each of the search history database 120, the social media database 122, the profile database 124, and the postings database 126 is a separate database. In other examples, two or more of the search history database 120, the social media database 122, the profile database 124, and the postings database 126 are integrally formed as a single database.

In the illustrated example, the processor(s) 202 are structured to include the database manager 114, the app manager 116, and the entry selector 118. The processor(s) 202 of the illustrated example include any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). Further, the memory 204 is, for example, volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, the memory 204 includes multiple kinds of memory, such as volatile memory and non-volatile memory.

The memory 204 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 204, the computer readable medium, and/or within the processor(s) 202 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

In the illustrated example, the input device(s) 206 enable a user, such as an information technician of the employment website entity, to provide instructions, commands, and/or data to the processor(s) 202. Examples of the input device(s) 206 include one or more of a button, a control knob, an instrument panel, a touch screen, a touchpad, a keyboard, a mouse, a speech recognition system, etc.

The output device(s) 208 of the illustrated example display output information and/or data of the processor(s) 202 to a user, such as an information technician of the employment website entity. Examples of the output device(s) 208 include a liquid crystal display (LCD), an organic light emitting diode (OLED) display, a flat panel display, a solid state display, and/or any other device that visually presents information to a user. Additionally or alternatively, the output device(s) 208 may include one or more speakers and/or any other device(s) that provide audio signals for a user. Further, the output device(s) 208 may provide other types of output information, such as haptic signals.

FIG. 3 is a block diagram of electronic components 300 of the mobile device 108. As illustrated in FIG. 3, the electronic components 300 include a processor 302, memory 304, a communication module 306, a camera 308, a global positioning system (GPS) receiver 310, an accelerometer 312, a gyroscope 314, the touchscreen 106, analog buttons 316, a microphone 318, and a speaker 320.

The processor 302 (also referred to as a microcontroller unit and a controller) of the illustrated example includes any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). Further, the memory 304 is, for example, volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, the memory 304 includes multiple kinds of memory, such as volatile memory and non-volatile memory.

The memory 304 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 304, the computer readable medium, and/or within the processor(s) 302 during execution of the instructions.

The communication module 306 includes wireless network interface(s) to enable communication with external networks (e.g., the network 110 of FIG. 1). The communication module 306 also includes hardware (e.g., processors, memory, storage, antenna, etc.) and software to control the wireless network interface(s). In the illustrated example, the communication module 306 includes one or more communication controllers for cellular networks (e.g., Global System for Mobile Communications (GSM), Universal Mobile Telecommunications System (UMTS), Long Term Evolution (LTE), Code Division Multiple Access (CDMA)), Near Field Communication (NFC) and/or other standards-based networks (e.g., WiMAX (IEEE 802.16m), local area wireless network (including IEEE 802.11 a/b/g/n/ac or others), Wireless Gigabit (IEEE 802.11ad), etc.). The external network(s) (e.g., the network 110) may be a public network, such as the Internet; a private network, such as an intranet; or combinations thereof, and may utilize a variety of networking protocols now available or later developed including, but not limited to, TCP/IP-based networking protocols.

In the illustrated example, the camera 308 is configured to capture image(s) and/or video near the mobile device 108. The GPS receiver 310 receives a signal from a global positioning system to determine a location of the mobile device 108. Further, the accelerometer 312, the gyroscope 314, and/or another sensor of the mobile device 108 collects data to determine an orientation of the mobile device 108. For example, the camera 308 collects the video, the GPS receiver 310 determines the location, and the accelerometer 312 and/or the gyroscope 314 determine the orientation to enable the employment app 104 to generate AR interface(s).

The touchscreen 106 of the illustrated example is (1) an output device that presents interfaces of the employment app 104 to the candidate 102 and (2) an input device that enables the candidate 102 to input information by touching the touchscreen 106. For example, the touchscreen 106 is configured to detect when the candidate selects a digital button of an interface presented via the touchscreen 106. The analog buttons 316 are input devices located along a body of the mobile device 108 and are configured to collect information from the candidate 102. The microphone 318 is an input device that is configured to collect an audio signal. For example, the microphone 318 collects an audio signal that includes a voice command of the candidate 102. Further, the speaker 320 is an output device that is configured to emit an audio output signal for the candidate 102.

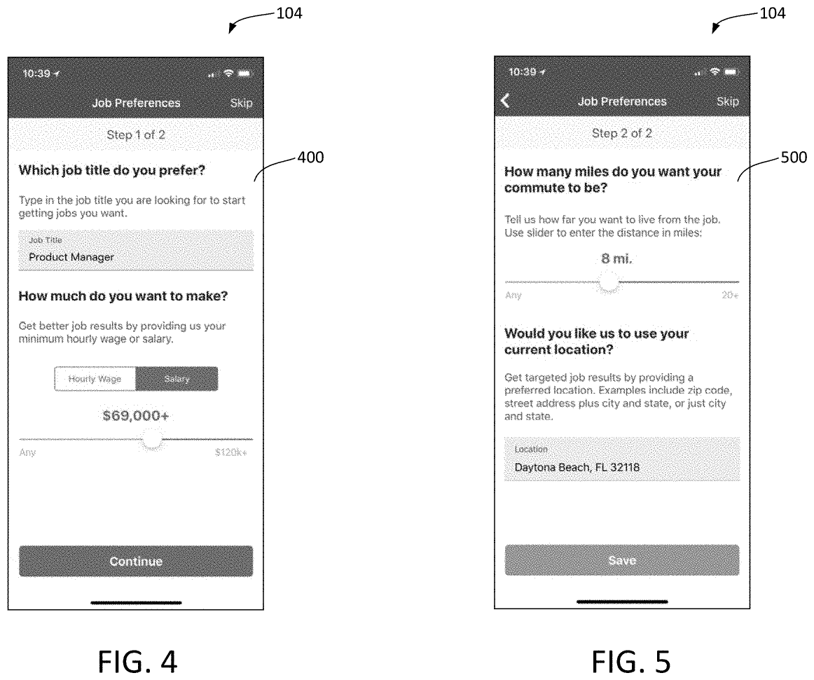

FIGS. 4-15 depict example interfaces of the employment app 104. The example interfaces are configured to be presented via the touchscreen 106 of the mobile device 108. The interfaces are particularly structured, individually and in conjunction with each other, to present information for employment postings in an easy-to-follow manner that enables the candidate 102 to intuitively identify and apply for nearby employment opportunities that correspond with employment preferences of the candidate 102.

FIG. 4 illustrates an example preferences interface 400 that is configured to enable the employment app 104 to collect employment preferences from the candidate 102. For example, the candidate preferences collected via the preferences interface 400 enable the remote server 100 of the employment website entity to generate a candidate profile for the candidate 102. In the illustrated example, the preferences interface 400 includes a textbox to enable the employment app 104 to collect a preferred employment title from the candidate 102. Further, the preferences interface 400 includes a digital toggle that enables the employment app 104 to collect a preferred type of income as selected by the candidate 102. For example, the digital toggle enables the candidate 102 to select between an hourly wage and a salary. Further, the preferences interface 400 includes a digital slide bar that enables the employment app 104 to collect a preferred income level as selected by the candidate 102. The employment app 104 adjusts the digital slide bar based on the type of income that the candidate 102 selected via the digital toggle. In the illustrated example, the digital slide bar corresponds with a salary income as a result of the candidate 102 identifying a salary via the digital toggle. Alternatively, the digital slide bar corresponds with an hourly wage income as a result of the candidate 102 identifying an hourly wage via the digital toggle. Further, the preferences interface 400 includes a continue button (e.g., identified by “Continue” in FIG. 4) that enables the candidate 102 to proceed to another preferences interface 500. In some examples, the database manager 114 stores the employment preferences collected via the preferences interface 400 in the profile database 124 in response to the employment app 104 instructing the app manager 116 that the candidate 102 has selected the continue button.

FIG. 5 illustrates the preferences interface 500 that is configured to enable the employment app 104 to collect employment preferences from the candidate 102. For example, the candidate preferences collected via the preferences interface 500 enable the remote server 100 of the employment website entity to generate a candidate profile for the candidate 102. In the illustrated example, the preferences interface 500 includes a digital slide bar that enables the employment app 104 to collect a preferred maximum commute distance as selected by the candidate 102. The preferences interface 500 also includes a textbox that enables the employment app 104 to collect a preferred employment region from the candidate 102. The preferred employment region may be identified by a city, a state, a zip code, an area code, and/or any combination thereof. Further, the preferences interface 500 includes a save button (e.g., identified by “Save” in FIG. 5) that enables the candidate 102 to proceed to another interface of the employment app 104. For example, the database manager 114 stores the employment preferences collected via the preferences interface 500 in the profile database 124 in response to the employment app 104 instructing the app manager 116 that the candidate 102 has selected the continue button.

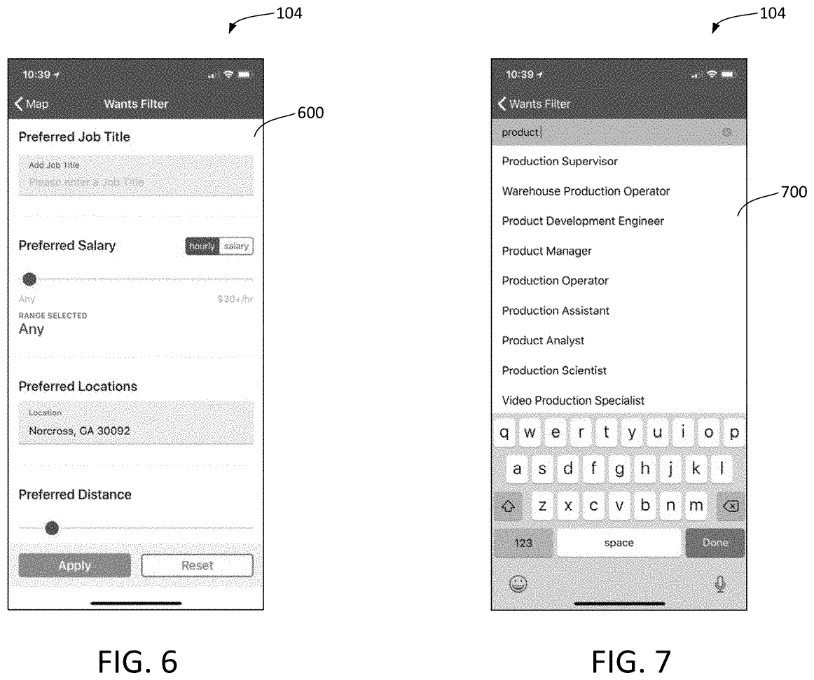

FIG. 6 illustrates a first portion of an example filter interface 600. As illustrated in FIG. 6, the filter interface 600 is configured to enable the employment app 104 to collect employment preferences from the candidate 102. For example, the employment preferences collected via the filter interface 600 enable the app manager 116 of the remote server 100 to identify which employment postings to present to the candidate 102 by filtering out other employment postings that do not match the preferences of the candidate 102. The filter interface 600 is configured to be utilized in addition to and/or as an alternative to the preferences interfaces 400, 500.

In the illustrated example, the filter interface 600 includes a textbox to enable the employment app 104 to collect a preferred employment title from the candidate 102. Further, the filter interface 600 includes a digital toggle that enables the employment app 104 to collect a preferred type of income as selected by the candidate 102. The filter interface 600 also includes a digital slide bar that enables the employment app 104 to collect a preferred income level as selected by the candidate 102. The employment app 104 adjusts the digital slide bar based on the type of income that the candidate 102 selected via the digital toggle. Further, the filter interface 600 includes another textbox that enables the employment app 104 to collect a preferred employment region from the candidate 102. Additionally, the filter interface 600 includes a digital slide bar that enables the employment app 104 to collect a preferred maximum commute distance as selected by the candidate 102.

The filter interface 600 of the illustrated example also includes an apply button (e.g., identified by “Apply” in FIG. 6) and a reset button (e.g., identified by “Reset” in FIG. 6). In response to the candidate 102 selecting the apply button, the employment app 104 causes the app manager 116 to apply the employment preferences in order to select which employment postings to present to the candidate 102. In some examples, the database manager 114 stores the employment preferences collected via the filter interface 600 in the profile database 124 to enable the remote server 100 to determine the candidate profile in response to the employment app 104 indicating to the app manager 116 that the candidate 102 has selected the continue button. In response to the candidate 102 selecting the reset button, the employment app 104 causes the app manager 116 to not save and/or delete employment preferences collected via the filter interface 600.

FIG. 7 illustrates an example position interface 700 of the employment app 104. The position interface 700 is configured to enable the employment app 104 to collect a preferred employment title from the candidate 102. For example, the employment app 104 presents the position interface 700 in response to the candidate 102 selecting the preferred employment title textbox of the filter interface 600. In the illustrated example, the position interface 700 includes a textbox that enables the candidate 102 to provide the preferred employment title to the employment app 104. Further, the position interface 700 includes a list of suggested employment titles that are identified by the app manager 116 based on text that has been entered into the textbox by the candidate 102. Each of the suggested employment titles in the list are selectable as a digital button, thereby enabling the candidate 102 to select the preferred employment title from the list without having to complete typing the preferred employment title into the textbox via a digital keypad.

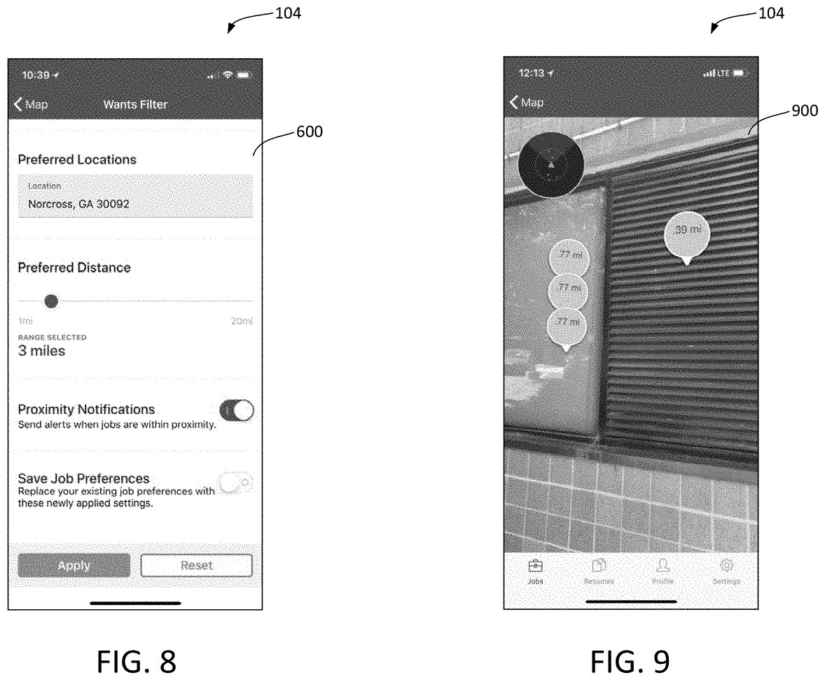

FIG. 8 illustrates a second portion of the filter interface 600. For example, the employment app 104 transitions between the first portion and the second portion of the filter interface 600 in response to the candidate 102 scrolling (e.g., swiping along the touchscreen 106) upward and/or downward along the filter interface 600. As illustrated in FIG. 8, the second portion of the filter interface includes the textbox for the preferred employment region, the digital slide bar for the preferred maximum commute distance, the apply button, and the reset button.

Additionally, in the illustrated example, the filter interface 600 includes another digital toggle that enables the employment app 104 to identify whether the candidate 102 would like to receive alerts and/or notifications (e.g., push notifications) when the candidate 102 is within the vicinity of an employment opportunity that corresponds with the provided preferences. For example, the candidate 102 selects the digital toggle to toggle between an on-setting and an off-setting.

Further, the filter interface 600 of the illustrated example includes yet another digital toggle that enables the employment app 104 to identify whether to replace the employment preferences collected via the preferences interfaces 400, 500 with the employment preferences collected via the filter interface 600. For example, in response to the candidate 102 positioning the digital toggle in the on-position, the employment app 104 causes the app manager 116 to instruct the database manager 114 to replace the employment preferences stored in the profile database 124. In response to the candidate 102 positioning the digital toggle in the off-position, the employment app 104 does not cause the app manager 116 to instruct the database manager 114 to replace the employment preferences stored in the profile database 124.

FIG. 9 illustrates an example augmented reality (AR) interface 900 (also referred to as an AR balloon interface and a first AR interface) of the employment app 104 that is displayed via the touchscreen 106 of the mobile device 108. The AR interface 900 is structured to present information for employment postings in an easy-to-follow manner that enables the candidate 102 to intuitively identify nearby employment opportunities that are of interest to the candidate 102. As illustrated in FIG. 9, the AR interface 900 is generated by the employment app 104 by overlaying a computer-generated (CG) layer (also referred to as an AR balloon layer and a first CG layer) onto video that is captured by the camera 308 of the mobile device 108. The employment app 104 generates and presents the AR interface 900 in real-time such that the AR interface 900 includes the video currently being captured by the camera 308 without noticeable lag. In the illustrated example, the CG layer includes balloons that each corresponds to a respective employment location. Further, each employment location corresponds with one or more employment opportunities that the app manager 116 identifies as matching the employment preferences of the candidate 102. In the illustrated example, the AR interface 900 includes three balloons that represent different employment opportunities at the same employment location. In other examples, the AR interface 900 includes one balloon that represents all employment opportunities at a single employment location.

For each balloon, the employment app 104 determines a display location within the CG layer based on the current location of the mobile device 108 as identified by the GPS receiver 310, the employment location corresponding to the balloon as identified by the app manager 116, and the current orientation of the mobile device 108 as identified via the accelerometer 312 and/or the gyroscope 314 of the mobile device 108. For example, if the mobile device 108 is located and oriented such that an employment location is in front of and slightly to the left of the candidate 102, the display position of the corresponding balloon is to the left within the CG layer. Similarly, if the mobile device 108 is located and oriented such that an employment location is in front of and slightly to the right of the candidate 102, the display position of the corresponding balloon is to the right within the CG layer. If the mobile device 108 is located and oriented such that an employment location is behind an/or to the side of the candidate 102, the CG layer does not include a balloon for that employment location.

Further, for each balloon, the employment app 104 determines a display size within the CG layer based on a distance between the current location of the mobile device 108 as identified by the GPS receiver 310 and the employment location corresponding to the balloon as identified by the app manager 116. For example, a larger display size of a balloon corresponds with a shorter distance to an employment location to indicate that the candidate 102 is relatively close to the employment position. In contrast, a smaller display size of a balloon corresponds with a longer distance to an employment location to indicate that the candidate 102 is relatively far from the employment location.

The employment app 104 of the illustrated example also is configured to consider other characteristics, in addition to the distance to the employment location, when determining a display size for a balloon within the CG layer. Such other characteristics may include a size and/or shape of a display of the mobile device 108 and/or a number of balloons to be simultaneously presented on the mobile device 108. For example, to determine a display size of a balloon based on a size and/or shape of a display of the mobile device 108, the employment app 104 is configured to determine the display size as a percentage of a size (e.g., a percentage of pixels) of the display of the mobile device 108. That is, a shorter distance to an employment location corresponds with a greater percentage of display pixels for a balloon, and a longer distance to an employment location corresponds with a smaller percentage of display pixels for a balloon. Additionally or alternatively, to determine a display size of a balloon based on the number of balloons to be simultaneously displayed on the mobile device 108, the employment app 104 is configured to determine the display size of a balloon based on a scale factor that inversely corresponds with the number of balloons to be included in a display. That is, when the number of balloons to be included in a display is large, the employment app 104 applies a small scale factor to reduce the display sizes of the balloons in order to enable more balloons to be viewed on the display. In contrast, when the number of balloons to be included in a display is small, the employment app 104 applies a large scale factor to increase the display sizes of the balloons in order to facilitate the candidate 102 in more easily viewing each of the limited number of balloons.

Further, in some examples, the relationship between a distance to an employment location and a corresponding balloon size is linear. In other examples, the relationship between a distance to an employment location and a corresponding balloon size is exponential. That is, to further highlight employment locations that are particularly close to the current location of the candidate 102, the size of a balloon increases exponentially relative to a corresponding distance to an employment location as the candidate 102 approaches the employment location. Additionally, in the illustrated example, each of the balloons includes text that identifies the relative distance to the corresponding employment location to further facilitate the candidate 102 in locating the employment location.

The CG layer of the AR interface 900 includes different display locations and different display sizes for the balloons to facilitate the candidate 102 in identifying the employment locations relative to that of the candidate 102. Further, in the illustrated example, the employment app 104 dynamically adjusts, in real-time, the display location and/or the display size of one or more of the balloons within the AR interface 900 based on detected movement of the mobile device 108. For example, a display size of a balloon (1) increases as the candidate 102 approaches a corresponding employment location and (2) decreases as the candidate 102 moves away from the corresponding employment location. Further, if the candidate 102 turns in a rightward direction, a display location of a balloon slides along the AR interface 900 in a leftward direction. Similarly, if the candidate 102 turns in a leftward direction, a display location of a balloon slides along the AR interface 900 in a rightward direction.

Further, in the illustrated example, the CG layer includes a radial map located near a corner (e.g., an upper left corner) of the AR interface 900. As illustrated in FIG. 9, the radial map includes a center that corresponds to the current location of the mobile device 108. The radial map also includes a sector (e.g., a slice) that identifies the current orientation of the mobile device 108. That is, the sector of the radial map indicates the direction that the candidate 102 is facing. Further, the radial map includes dots and/or other markers outside and/or within the sector. The dots within the sector correspond with employment locations that are in a direction-of-view of the candidate 102, and the dots outside of the sector correspond with employment locations that are away from the direction-of-view of the candidate 102. The employment app 104 includes the radial map to facilitate the candidate 102 in identifying nearby employment opportunities that are not in the current direction-of-view of the candidate 102. For example, upon identifying a dot within the radial map and to the left of the sector, the candidate 102 may turn to the left until a balloon appears in the AR interface 900 that corresponds with the employment location of the dot. That is, the employment app 104 dynamically adjusts, in real-time, the radial map of the AR interface 900 as the candidate 102 moves the location and/or orientation of the mobile device 108.

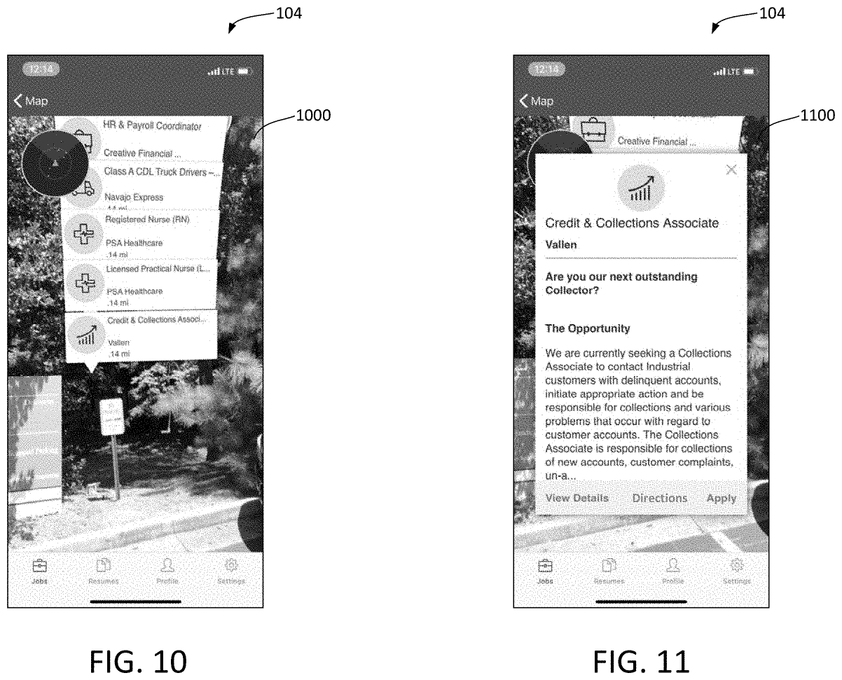

In the illustrated example, each of the balloons of the AR interface 900 is a digital button that is selectable by the candidate 102. FIG. 10 illustrates another example AR interface 1000 that is displayed by the employment app 104 via the touchscreen 106 of the mobile device 108 in response to the candidate 102 selecting one of the balloons of the AR interface 900.

As illustrated in FIG. 10, the AR interface 1000 (also referred to as an AR summary interface and a second AR interface) is generated by the employment app 104 by overlaying another computer-generated (CG) layer (also referred to as a summary layer and a second CG layer) onto video that is captured by the camera 308 of the mobile device 108. The employment app 104 generates and presents the AR interface 1000 in real-time such that the AR interface 1000 includes the video currently being captured by the camera 308 without noticeable lag. In the illustrated example, the CG layer includes a list of summaries of employment postings that correspond to the selected balloon of the AR interface 900. Each of the summaries includes an employment title, an employer name, and a relative distance for the employment posting. Further, the summaries included in the list correspond to employment postings for the employment location associated with the selected balloon that match the employment preferences of the candidate 102.

For example, in response to identifying that the candidate 102 selected one of the balloons of the AR interface 900, the employment app 104 collects information for one or more employment postings within the postings database 126 that corresponds with employment location of the selected balloon. For example, the employment app 104 collects employment postings information from the app manager 116, the app manager 116 collects the employment postings information from the entry selector 118, and the entry selector 118 retrieves the employment postings information from the postings database 126. Subsequently, the employment app 104 generates the CG layer of the AR interface 1000 to include summaries of the employment postings that match the employment preferences of the candidate 102. In the illustrated example, the employment app 104 also generates the CG layer of the AR interface 1000 to include the radial map.

In the illustrated example, each of the summaries of the AR interface 1000 is a digital button that is selectable by the candidate 102. FIG. 11 illustrates another example AR interface 1100 that is displayed by the employment app 104 via the touchscreen 106 of the mobile device 108 in response to the candidate 102 selecting one of the summaries of the AR interface 1000.

As illustrated in FIG. 11, the AR interface 1100 (also referred to as an AR details interface and a third AR interface) is generated by the employment app 104 by overlaying another computer-generated (CG) layer (also referred to as a details layer and a third CG layer) onto video that is captured by the camera 308 of the mobile device 108. The employment app 104 generates and presents the AR interface 1000 in real-time such that the AR interface 1000 includes the video currently being captured by the camera 308 without noticeable lag. In the illustrated example, the CG layer of the AR interface 1100 also overlays the CG layer of the AR interface 1000. As illustrated in FIG. 11, the CG layer of the AR interface 1100 includes a detailed description of the selected summary of the AR interface 1000.

Further, in the illustrated example, the CG layer of the AR interface 1100 includes a details button, a directions button, and an apply button. The employment app 104 presents additional details for the employment posting within the CG layer of the AR interface 1100 in response to identifying that the candidate 102 has selected the details button. The employment app 104 provides directions (e.g., turn-by-turn directions) to the employment location of the selected employment posting in response to identifying that the candidate 102 has selected the directions button. For example, the employment app 104 is configured to present visual directions via another AR interface. Additionally or alternatively, the employment app 104 is configured to emit audio directions to the candidate 102 via the speaker 320 of the mobile device 108. Further, the employment app 104 instructs the app manager 116 to submit a previously-obtained resume of the candidate 102 for the selected employment posting in response to identifying that the candidate 102 has selected the apply button.

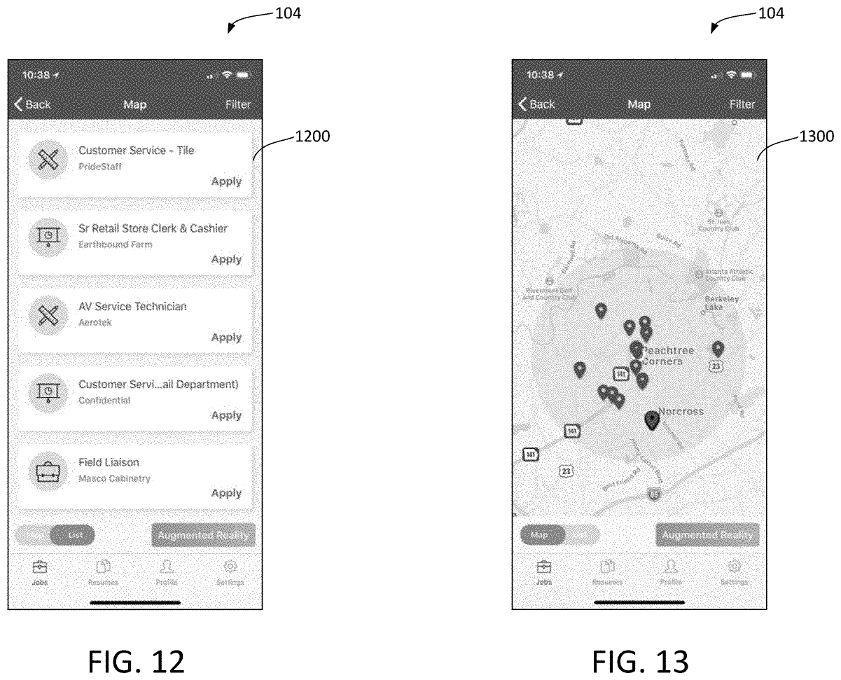

FIG. 12 illustrates another example interface 1200 of the employment app 104. The interface 1200 (also referred to as a list interface) is an alternative interface for presenting nearby employment postings to the candidate 102. As illustrated in FIG. 12, the interface 1200 includes a list of summaries for nearby employment postings that the app manager 116 of the remote server 100 has identified as matching the employment preferences of the candidate. For example, each of the summaries includes an employment title and an employer name for the employment posting. In the illustrated example, each of the summaries of the interface 1200 is a digital button that is selectable by the candidate 102. The employment app 104 presents a detailed description and/or other additional information for an employment posting in response to detecting that the candidate 102 has selected the digital button of the corresponding summary. Each of the summaries of the illustrated example also includes an apply button (e.g., identified by “Apply” in FIG. 12). The employment app 104 instructs the app manager 116 to submit a previously-obtained resume of the candidate 102 for the selected employment posting in response to identifying that the candidate 102 has selected the apply button.

Additionally, the interface 1200 of the illustrated example also includes an AR button and a digital toggle. The AR button (e.g., identified by “Augmented Reality” in FIG. 12) is a digital button that enables the candidate 102 to view the AR interface 900. For example, in response to identifying that the candidate 102 has selected the AR button, the employment app 104 displays the AR interface 900 instead of the interface 1200. Similarly, the AR interface 900 includes a map button (e.g., identified by “<Map” in FIG. 9) that enables the candidate 102 to transition from the AR interface 900 to the interface 1200 or a map interface (e.g., an interface 1300 of FIG. 13). That is, the AR button and the map button enable the candidate to toggle the employment app 104 between the AR interface 900 and the interface 1200. Further, the digital toggle of the interface 1200 enables the candidate 102 to toggle between the interface 1200 and the interface 1300. For example, the employment app 104 (1) presents the interface 1200 in response to the candidate 102 selecting a list position of the digital toggle and (2) presents the interface 1300 in response to the candidate 102 selecting a map position of the digital toggle.

FIG. 13 illustrates the interface 1300 (also referred to as a map interface) of the employment app 104. The interface 1300 is another alternative interface for presenting nearby employment postings to the candidate 102. As illustrated in FIG. 13, the interface 1300 includes a map. The interface 1300 also includes (1) the AR button that enables the candidate 102 to view the AR interface 900 and (2) the digital toggle that enables the candidate 102 to transition between the interface 1200 and the interface 1300.

In the illustrated example, the map of the interface 1300 includes a circle that is centered about the current location of the candidate 102. The circle represents a geographic area that is within a predetermined distance of the current location of the candidate 102. Further, the map includes one or more pins within the circle. Each of the pins represent an employment posting and/or an employment location with employment posting(s) that the app manager 116 has identified as corresponding to the employment preferences of the candidate 102. Further, each of the pins of the interface 1300 is a digital button that is selectable by the candidate 102.

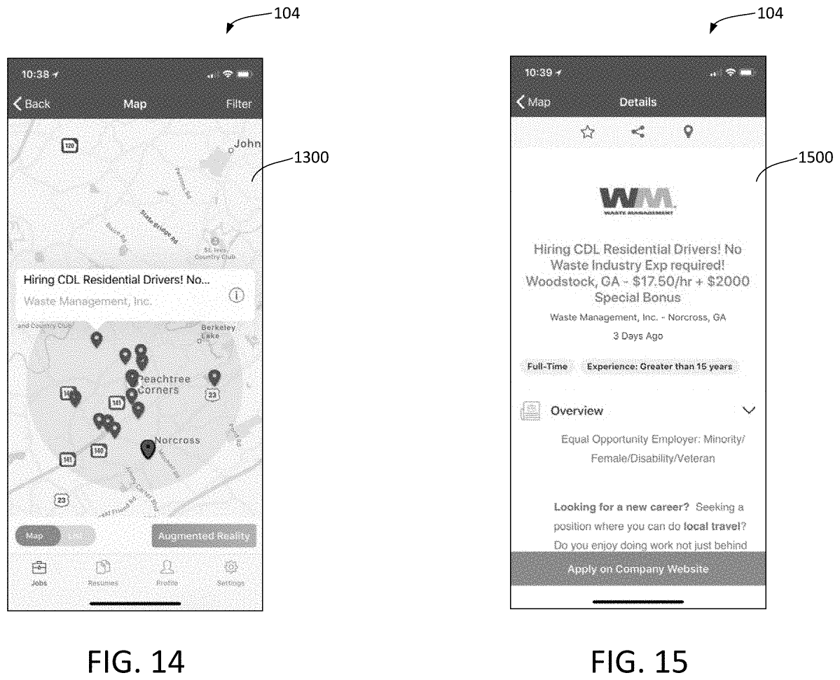

FIG. 14 illustrates the interface 1300 after the employment app 104 has detected that the candidate 102 selected one of the pins of the map. As illustrated in FIG. 14, the employment app 104 presents a summary and/or other information for an employment posting in response to detecting that the candidate 102 has selected a digital button of a corresponding pin. In the illustrated example, the summary is a digital button that is selectable by the candidate 102.

FIG. 15 illustrates another example interface 1500 of the employment app 104. For example, the employment app 104 displays the interface 1500 in response to detecting that the candidate 102 has selected a summary corresponding with a pin on the map of the interface 1300. The interface 1500 includes a detailed description and/or other additional information for an employment posting corresponding with the summary and the selected pin. In the illustrated example, the interface 1500 includes an apply button (e.g., identified by “Apply on Company Website” in FIG. 15). For example, in response to identifying that the candidate 102 has selected the apply button, the employment app 104 instructs the app manager 116 to submit a previously-obtained resume of the candidate 102 for the selected employment posting.

In the illustrated example, the employment app 104 is configured to receive a selection of a digital button, toggle, slide bar, textbox, etc. of the interfaces 400, 500, 600, 700, 900, 1000, 1100, 1200, 1300, 1500 tactilely (e.g., via the touchscreen 106, the analog buttons 316, etc. of the mobile device 108) and/or audibly (e.g., via the microphone 318 and speech-recognition software of the mobile device 108) from the candidate 102.

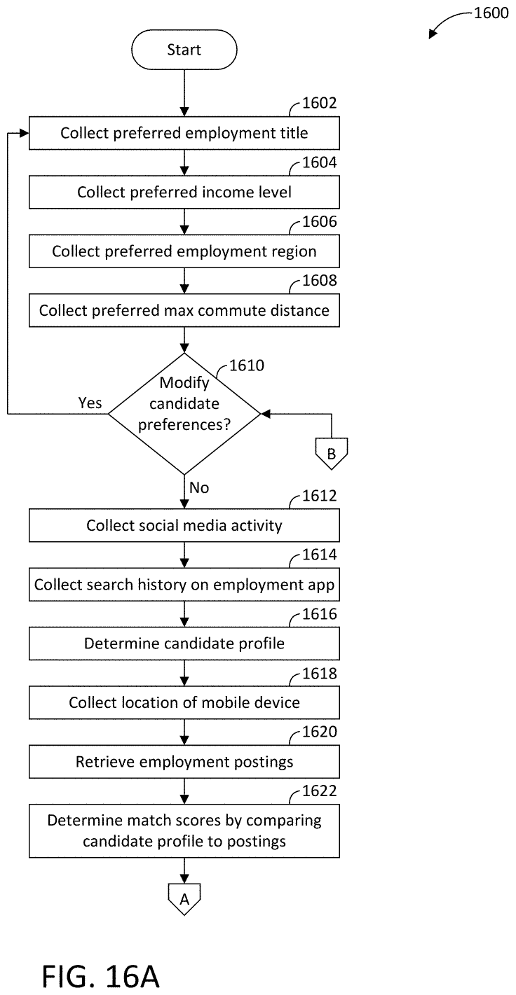

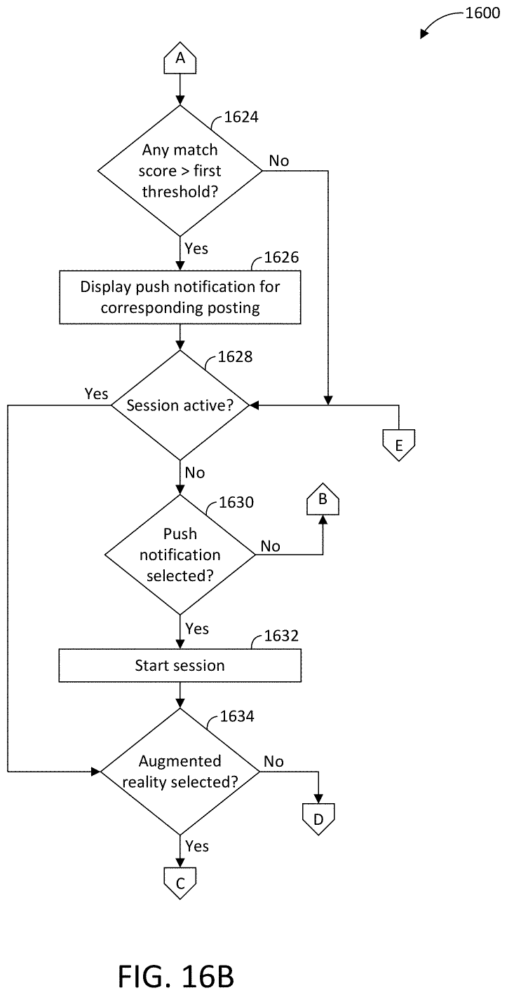

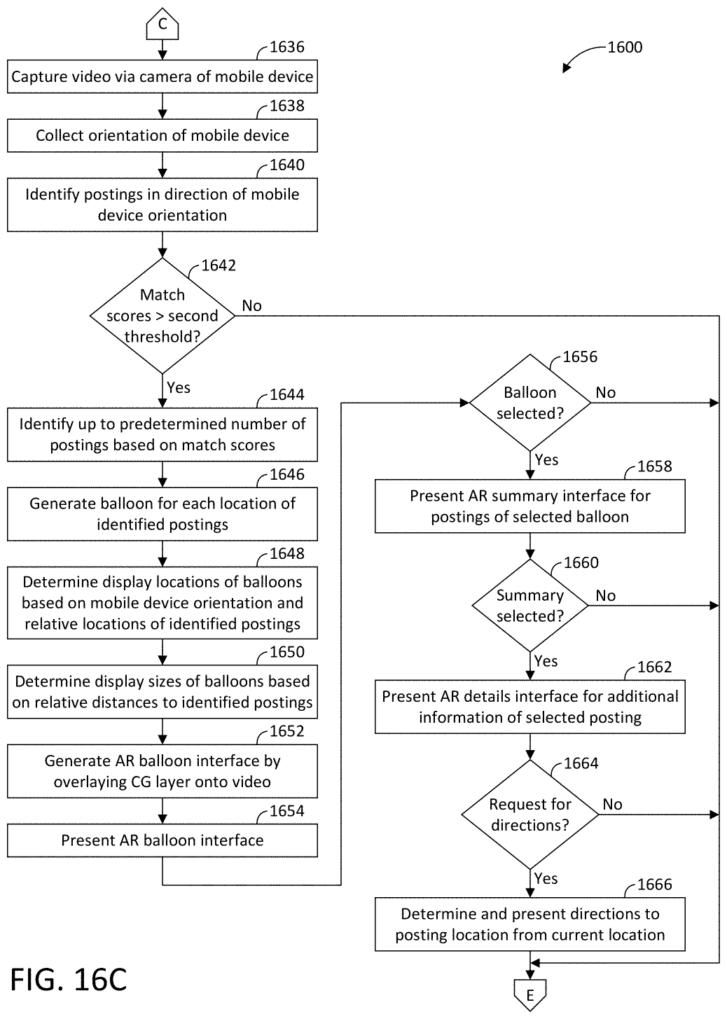

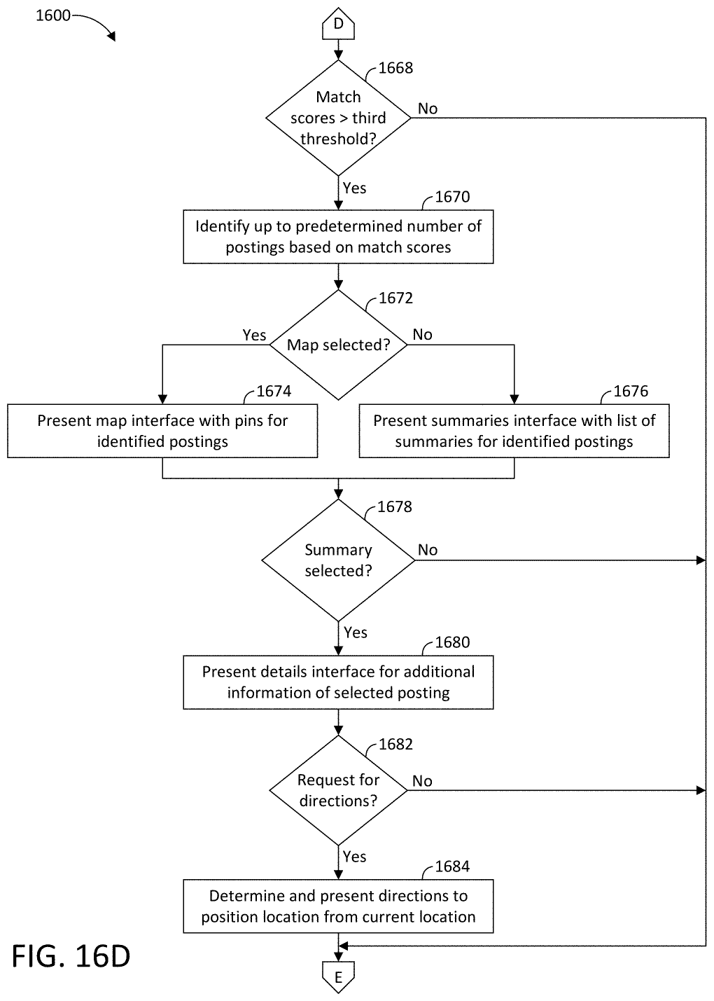

FIGS. 16A-16D is a flowchart of an example method 1600 to present employment information to a candidate via a location-based augmented reality employment app. The flowchart of FIGS. 16A-16D is representative of machine readable instructions that are stored in memory (such as the memory 204 of FIG. 2 and/or the memory 304 of FIG. 3) and include one or more programs which, when executed by one or more processors (such as the processor(s) 202 of FIG. 2 and/or the processor 302 of FIG. 3), cause the remote server 100 of the employment website entity to implement the example database manager 114, the example app manager 116, and/or the example entry selector 118 of FIGS. 1 and 2 and/or cause the mobile device 108 to implement the example employment app 104 of FIGS. 1 and 4-15. While the example program is described with reference to the flowchart illustrated in FIGS. 16A-16D, many other methods of implementing the example employment app 104, the example database manager 114, the example app manager 116, and/or the example entry selector 118 may alternatively be used. For example, the order of execution of the blocks may be rearranged, changed, eliminated, and/or combined to perform the method 1600. Further, because the method 1600 is disclosed in connection with the components of FIGS. 1-15, some functions of those components will not be described in detail below.

As illustrated in FIG. 16A, the method 1600 starts at block 1602 at which the employment app 104 collects a preferred employment title from the candidate 102. At block 1604, the employment app 104 collects a preferred income level from the candidate 102. At block 1606, the employment app 104 collects a preferred employment region from the candidate 102. At block 1608, the employment app 104 collects a preferred maximum commute distance from the candidate 102. Further, the app manager 116 of the remote server 100 collects the preferred employment title, the preferred income level, the preferred employment region, and the preferred maximum commute distance from the employment app 104 via the network 110. Also, the database manager 114 of the remote server 100 receives the employment preferences from the app manager 116 and stores the employment preferences in the profile database 124.

At block 1610, the employment app 104 determines whether the candidate 102 has requested to modify any of the employment preferences. In response to the employment app 104 determining that the candidate 102 has requested to modify employment preference(s), the method 1600 returns to block 1602. Otherwise, in response to the employment app 104 determining that the candidate 102 has not requested to modify employment preference(s), the method 1600 proceeds to block 1610.

At block 1612, the remote server 100 collects social media activity of the candidate 102 via the network 112. Further, the database manager 114 of the remote server 100 stores the collected social media activity in the social media database 122. At block 1614, the remote server 100 collects search history of the candidate 102 on the employment app 104. For example, the app manager 116 collects the search history from the employment app 104 via the network 112. Further, the database manager 114 of the remote server 100 receives the search history from the app manager 116 and stores the collected search history in the search history database 120.

At block 1616, the app manager 116 of the remote server 100 determines a candidate profile of the candidate 102. For example, the app manager 116 determines the candidate profile based on the employment preferences, the social media activity, the search history, and/or other information corresponding with the candidate 102. In some examples, the entry selector 118 retrieves (1) the employment preferences of the candidate 102 from profile database 124, (2) the search history of the candidate 102 of the candidate 102 from the search history database 120, and (3) the social media activity of the candidate 102 from the social media database 122 to enable the app manager 116 of the remote server 100 to determine the candidate profile of the candidate 102. Further, the database manager 114 of the remote server 100 receives the candidate profile from the app manager 116 and stores the candidate profile in the profile database 124.

At block 1618, the GPS receiver 310 of the mobile device 108 identifies the current location of the mobile device 108. Further, the app manager 116 of the remote server 100 collects the current location from the mobile device 108 via the network 110. At block 1620, the entry selector 118 retrieves information of employment postings from the postings database 126 for the app manager 116. At block 1622, the app manager 116 of the remote server 100 determines a match score for each of the employment postings by comparing the candidate profile of the candidate 102 to the employment posting information. A match score indicates a likelihood that the candidate is interested in the position of the corresponding employment posting. For example, a greater match score corresponds with a greater likelihood that the candidate 102 is interested in the corresponding employment position.

As illustrated in FIG. 16B, the method 1600 proceeds to block 1624 at which the app manager 116 of the remote server 100 determines whether any of the calculated match scores is greater than a predetermined first threshold score. For example, the first threshold score corresponds with a high likelihood that the candidate 102 is interested in a corresponding employment position. In response to the app manager 116 determining that no match score is greater than the first threshold score, the method 1600 proceeds to block 1628. Otherwise, in response to the app manager 116 determining that at least one match score is greater than the first threshold score, the method 1600 proceeds to block 1626 at which the app manager 116 causes the employment app 104 to display, via the touchscreen 106 of the mobile device 108, a push notification for the corresponding employment posting.

At block 1628, the employment app 104 determines whether a session of the employment app 104 is currently active for the candidate 102. In response to the employment app 104 determining that a session is currently active, the method 1600 proceeds to block 1634. Otherwise, in response to the employment app 104 determining that a session is not currently active, the method 1600 proceeds to block 1630.

At block 1630, the employment app 104 determines whether the candidate 102 has selected the push notification (e.g., via the touchscreen 106). In response to the employment app 104 determining that the push notification has not been selected, the method 1600 returns to block 1610. Otherwise, in response to the employment app 104 determining that the push notification has been selected, the method 1600 proceeds to block 1632 at which the employment app 104 starts a session of the employment app 104 for the candidate 102. At block 1634, the employment app 104 determines whether the candidate 102 has selected for augmented reality to be utilized. In response to the employment app 104 determining that augmented reality has been selected, the method 1600 proceeds to block 1636 (FIG. 16C). Otherwise, in response to the employment app 104 determining that augmented reality has not been selected, the method 1600 proceeds to block 1668 (FIG. 16D).

Turning to FIG. 16C, the camera 308 of the mobile device 108 captures video at block 1636. At block 1638, the accelerometer 312, the gyroscope 314, and/or another sensor determines the orientation of the mobile device 108. Further, the app manager 116 of the remote server 100 collects the orientation of the mobile device 108 from the mobile device 108 via the network 110. At block 1640, the app manager 116 identifies employment postings that are in the field-of-view of the candidate 102 based on the current location and the current orientation of the mobile device 108. Further, the app manager 116 identifies the match scores that correspond to the identified employment postings.

At block 1642, the app manager 116 determines whether any of the match scores is greater than a predetermined second threshold score. For example, the second threshold score corresponds with a likelihood that the candidate 102 is interested in a corresponding employment position. In some examples, the second threshold of block 1642 equals the first threshold of block 1624. In other examples, the second threshold is less than the first threshold such that employment app 104 presents push notifications at block 1626 for only a portion of the employment postings having match scores that are greater than the second threshold. In response to the app manager 116 determining that no match score is greater than the second threshold score, the method 1600 returns to block 1628. Otherwise, in response to the app manager 116 determining that at least one match score is greater than the second threshold score, the method 1600 proceeds to block 1644.

At block 1644, the app manager 116 identifies up to a predetermined number of employment postings that have match scores exceeding the second threshold score. For example, the predetermined number of employment postings corresponds with a number of balloons that the employment app 104 is able to clearly display via the touchscreen 106 of the mobile device 108. In some examples, when the number of match scores exceeding the second threshold score is greater than the predetermined number of employment postings, the app manager 116 selects the employment postings with the highest match scores. Further, the app manager 116 transmits information of the identified employment postings, such as the corresponding employment locations, to the employment app 104 via the network 110.

At block 1646, the employment app 104 creates a balloon for the CG layer of the AR interface 900 for each identified employment posting and/or for each employment location corresponding to an identified employment posting. At block 1648, the employment app 104 determines a display location for each of the balloons of the CG layer based on the current orientation of the mobile device 108, the current location of the mobile device 108, and the employment location corresponding to the particular balloon. At block 1650, the employment app 104 determines a display location for each of the balloons of the CG layer based on the distance between the current location of the mobile device 108 and the employment location corresponding to the particular balloon. At block 1652, the employment app 104 generates the AR interface 900 by overlaying the CG layer with the balloons onto the video captured by the camera 308. At block 1654, the employment app 104 presents the AR interface 900 to the candidate 102 via the touchscreen 106 of the mobile device 108.

At block 1656, the employment app 104 determines whether a balloon of the AR interface 900 has been selected by the candidate 102. In response to the employment app 104 determining that a balloon has not been selected, the method 1600 returns to block 1628. Otherwise, in response to the employment app 104 determining that a balloon has been selected, the method 1600 proceeds to block 1658 at which the employment app 104 presents the AR interface 1000 that includes a list of summaries of employment postings that correspond with the selected balloon. At block 1660, the employment app 104 determines whether a summary of the AR interface 1000 has been selected by the candidate 102. In response to the employment app 104 determining that a summary has not been selected, the method 1600 returns to block 1628. Otherwise, in response to the employment app 104 determining that a summary has been selected, the method 1600 proceeds to block 1662 at which the employment app 104 presents the AR interface 1100 that includes a detailed description of the employment posting that corresponds with the selected summary. Further, the AR interface 1100 also includes a details buttons, a directions button, and/or an apply button.

At block 1664, the employment app 104 determines whether the directions button of the AR interface 1100 has been selected by the candidate 102. Additionally or alternatively, the employment app 104 determines whether the details button and/or the apply button of the AR interface 1100 has been selected by the candidate 102. In response to the employment app 104 determining that a button has not been selected, the method 1600 returns to block 1628. Otherwise, in response to the employment app 104 determining that the directions button has been selected, the method 1600 proceeds to block 1666 at which the employment app 104 determines and presents directions (e.g., turn-by-turn directions) from the current location of the mobile device 108 to the location corresponding with the selected employment posting. Further, the employment app 104 provides additional information regarding the selected employment posting in response to determining that the details button has been selected and/or submits a resume of the candidate 102 to an employer of the selected employment posting in response to determining that the apply button has been selected. Subsequently, the method 1600 returns to block 1628.

Turning to FIG. 16D, the app manager 116, at block 1668, determines whether any of the match scores is greater than a second threshold score. In response to the app manager 116 determining that no match score is greater than the second threshold score, the method 1600 returns to block 1628. Otherwise, in response to the app manager 116 determining that at least one match score is greater than the second threshold score, the method 1600 proceeds to block 1670.

At block 1670, the app manager 116 identifies up to a predetermined number of employment postings that have match scores exceeding a third threshold score. For example, the predetermined number of employment postings corresponds with a number of pins and/or summaries that the employment app 104 is able to clearly display via the touchscreen 106 of the mobile device 108. In some examples, when the number of match scores exceeding the third threshold score is greater than the predetermined number of employment postings, the app manager 116 selects the employment postings with the highest match scores. Further, the app manager 116 transmits information of the identified employment postings, such as the corresponding employment locations, to the employment app 104 via the network 110.

At block 1672, the employment app 104 determines whether the candidate 102 has selected for a map to be displayed. In response to the employment app 104 determining that display of a map has been selected, the method 1600 proceeds to block 1674 at which the employment app 104 presents the interface 1300 that includes a map with pins corresponding to the identified employment postings. Further, the employment app 104 presents a summary of an employment posting in response to detecting that the candidate 102 has selected a corresponding pin on the map of the interface 1300. Otherwise, in response to the employment app 104 determining that display of a map has not been selected, the method 1600 proceeds to block 1676 at which the employment app 104 presents the interface 1200 that includes a list of summaries of the identified employment postings.

At block 1678, the employment app 104 determines whether a summary has been selected by the candidate 102. In response to the employment app 104 determining that a summary has not been selected, the method 1600 returns to block 1628. Otherwise, in response to the employment app 104 determining that a summary has been selected, the method 1600 proceeds to block 1680 at which the employment app 104 presents the interface 1500 that includes a detailed description of the employment posting that corresponds with the selected summary. Further, in some examples, the interface 1500 also includes a details buttons, a directions button, and/or an apply button.

At block 1682, the employment app 104 determines whether the directions button of the interface 1500 has been selected by the candidate 102. Additionally or alternatively, the employment app 104 determines whether the details button and/or the apply button of the interface 1500 has been selected by the candidate 102. In response to the employment app 104 determining that a button has not been selected, the method 1600 returns to block 1628. Otherwise, in response to the employment app 104 determining that the directions button has been selected, the method 1600 proceeds to block 1684 at which the employment app 104 determines and presents directions (e.g., turn-by-turn directions) from the current location of the mobile device 108 to the location corresponding with the selected employment posting. Further, the employment app 104 provides additional information regarding the selected employment posting in response to determining that the details button has been selected and/or submits a resume of the candidate 102 to an employer of the selected employment posting in response to determining that the apply button has been selected. Subsequently, the method 1600 returns to block 1628.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively. Additionally, as used herein, the term “module” refers to hardware with circuitry to provide communication, control and/or monitoring capabilities. A “module” may also include firmware that executes on the circuitry.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A system for providing location-based augmented reality for an employment candidate, the system comprising:
a mobile device comprising:
a camera to collect video;
a communication module configured to:
transmit, via wireless communication, a current location and a current orientation of the mobile device; and
receive, via wireless communication, up to a predetermined number of employment locations;
memory configured to store an employment app;
a processor configured to execute the employment app to:
generate, in real-time, a first computer-generated layer that includes a balloon for each of the employment locations, wherein, to generate the balloon for each of the employment locations, the employment app is configured to:
determine a display location of the balloon within the first computer-generated layer based on the employment location, the current location of the mobile device, and the current orientation of the mobile device; and
determine a display size of the balloon based on a distance between the current location of the mobile device and the employment location, wherein a larger display size corresponds with a shorter distance; and
generate, in real-time, a first augmented reality (AR) interface by overlaying the first computer-generated layer onto the video captured by the camera; and
a display configured to display, in real-time, the first AR interface, wherein the display location and the display size of each of the balloons indicate the employment locations to the employment candidate; and
a remote server configured to:
collect, via wireless communication, the current location and the current orientation of the mobile device;
identify up to the predetermined number of the employment locations based on, at least in part, the current location and the current orientation of the mobile device, wherein each of the employment locations corresponds with one or more employment postings; and
transmit, via wireless communication, the employment locations to the mobile device.

2. The system of claim 1, wherein the processor of the mobile device is configured to execute the employment app to dynamically adjust, in real-time, the display locations and the display sizes of the balloons of the first AR interface based on detected movement of the mobile device.

3. The system of claim 1, wherein each of the balloons includes text identifying the distance to the corresponding employment location.

4. The system of claim 1, wherein the first computer-generated layer further includes a radial map located near a corner of the first AR interface, wherein the radial map includes:
a center corresponding to the current location of the mobile device;
a sector that identifies the current orientation of the mobile device; and
dots outside of the sector that identify other employment locations surrounding the current location of the mobile device.

5. The system of claim 1, wherein the processor of the mobile device is configured to execute the employment app to collect employment preferences from the employment candidate via the mobile device.

6. The system of claim 5, wherein the employment preferences include a preferred employment title, a preferred income level, a preferred employment region, and a preferred maximum commute distance.

7. The system of claim 5, wherein the remote server is configured to generate a candidate profile based on, at least in part, the employment preferences collected by the employment app.

8. The system of claim 7, wherein the remote server is configured to generate the candidate profile further based on at least one of search history within the employment app and social media activity of the employment candidate.

9. The system of claim 5, wherein the remote server is configured to calculate a match score for each of a plurality of employment postings, wherein the match score indicates a likelihood that the employment candidate is interested in the employment posting.

10. The system of claim 9, wherein the remote server is configured to determine the employment locations of the employment postings for the first AR interface further based on the match scores of the plurality of employment postings.

11. The system of claim 10, wherein the match score of each of the employment postings identified by the remote server is greater than a predetermined threshold.

12. A method for providing location-based augmented reality for an employment candidate, the method comprising:
detecting a current location and a current orientation of a mobile device;
receiving, via wireless communication, up to a predetermined number of employment locations that are identified based on, at least in part, the current location and the current orientation of the mobile device, wherein each of the employment locations corresponds with one or more employment postings;
capturing video via a camera of the mobile device;
generating, in real-time via a processor of the mobile device, a first computer-generated layer that includes a balloon for each of the employment locations, wherein generating the first computer-generated layer includes:
determining a display location of the balloon within the first computer-generated layer based on the employment location, the current location of the mobile device, and the current orientation of the mobile device; and
determining a display size of the balloon based on a distance between the current location of the mobile device and the employment location, wherein a larger display size corresponds with a shorter distance;
generating, via the processor, a first augmented reality (AR) interface in real-time by overlaying the first computer-generated layer onto the video captured by the camera; and
displaying the first AR interface in real-time via a touchscreen of the mobile device, wherein the display location and the display size of each of the balloons are configured to indicate the employment locations to the employment candidate.

13. The method of claim 12, further including dynamically adjusting, in real-time, the display locations and the display sizes of the balloons of the first AR interface based on detected movement of the mobile device.

14. The method of claim 12, further including displaying, via the touchscreen, text in each of the balloons that identifies the distance to the corresponding employment location.

15. The method of claim 12, further including displaying, via the touchscreen, a radial map in the first computer-generated layer that is located near a corner of the first AR interface, wherein the radial map includes:
a center corresponding to the current location of the mobile device;
a sector that identifies the current orientation of the mobile device; and
dots outside of the sector that identify other employment locations surrounding the current location of the mobile device.

16. The method of claim 12, further including, in response to identifying that the employment candidate selected one of the balloons via the touchscreen:
collecting information for each of the employment postings at the employment location corresponding with the selected balloon;
generating, in real-time, a second computer-generated layer that includes a list of summaries for the employment postings at the employment location corresponding with the selected balloon;
generating, in real-time, a second AR interface by overlaying the second computer-generated layer onto the video captured by the camera; and
displaying, in real-time, the second AR interface via the touchscreen.

17. The method of claim 16, further including, in response to identifying that the employment candidate selected one of the summaries via the touchscreen:
generating, in real-time, a third computer-generated layer that includes a submit button, a directions button, and a detailed description of a selected employment posting corresponding with the selected summary;
generating, in real-time, a third AR interface by overlaying the third computer-generated layer onto the video captured by the camera; and
displaying, in real-time, the third AR interface via the touchscreen.

18. The method of claim 17, further including submitting a resume to an employer for the selected employment posting in response to identifying that the employment candidate selected the submit button via the touchscreen.

19. The method of claim 17, further including determining and presenting directions to the employment candidate for traveling from the current location to the selected employment location in response to identifying that the employment candidate selected the directions button via the touchscreen.

20. A computer readable medium including instructions which, when executed, cause a mobile device to:
detect a current location and a current orientation of the mobile device;
receive, via wireless communication, up to a predetermined number of employment locations that are identified based on, at least in part, the current location and the current orientation of the mobile device, wherein each of the employment locations corresponds with one or more employment postings;
capture video via a camera of the mobile device;
generate, in real-time, a first computer-generated layer that includes a balloon for each of the employment locations by:
determining a display location of the balloon within the first computer-generated layer based on the employment location, the current location of the mobile device, and the current orientation of the mobile device; and
determining a display size of the balloon based on a distance between the current location of the mobile device and the employment location, wherein a larger display size corresponds with a shorter distance;
generate a first augmented reality (AR) interface in real-time by overlaying the first computer-generated layer onto the video captured by the camera; and
display the first AR interface in real-time via a display of the mobile device, wherein the display location and the display size of each of the balloons are configured to indicate the employment locations to the employment candidate.
